(19) United States
(12) Patent Application Publication
(10) Pub. No.: US 2004/0211862 A1
(43) Pub. Date: Oct. 28, 2004

(54) Unmanned aerial vehicle with integrated wing battery

(76) Inventor: Daryl B. Elam, Benson, AZ (US)

Correspondence Address: MARK D. SARALINO (GENERAL), RENNER, OTTO, BOISELLE & SKLAR, LLP, 1621 EUCLID AVENUE, NINETEENTH FLOOR, CLEVELAND, OH, 44115-2191, US

(21) Appl. No.: 10/423,187

(22) Filed: Apr. 25, 2003

(51) Int. Cl. B64D 41/00

(52) U.S. Cl. 244/58

(57) ABSTRACT

An unmanned aerial vehicle, such as a remotely-piloted airplane, includes lift-producing wings that have batteries embedded or otherwise located within them. Locating the batteries within the wings allows more efficient use of the interior space of the unmanned vehicle. Space within a fuselage of the vehicle, which would otherwise be used for batteries, may be used for other components. Alternatively, fuselage, weight and/or size of the unmanned aerial vehicle may be reduced. In addition, locating the batteries within the wings may provide better structural performance of the wings, and/or may allow characteristics of the wings, such as inertia and moments, to be optimized.

### BACKGROUND OF THE INVENTION

1. Technical Field

The invention relates to unmanned aerial vehicles (UAVs) and in particular to UAVs that utilize batteries to provide electrical power.

2. Description of Related Art

Pilotless air vehicles include vehicles that are remotely piloted from other locations, and vehicles that are piloted using on-board guidance systems, such as cruise missiles and drones. Such air vehicles may utilize fixed or articulatable wings in order to provide lift, and in some cases in order to provide control surfaces for changing flight direction. The operative components, such as engines, batteries, and electrical and electronic equipment, of such pilotless vehicles, have generally been located within the fuselage. It will be appreciated that reductions in weight, size, complexity, and cost are desirable for such vehicles, and that improvements in performance are also desirable.

### SUMMARY OF THE INVENTION

According to an aspect of the invention, an unmanned aerial vehicle (UAV) includes a fuselage; a wing connected to the fuselage; and at least one battery at least partially in the wing.

According to another aspect of the invention, an unmanned aerial vehicle (UAV) includes a fuselage; an electricity-consuming component in the fuselage; a wing connected to the fuselage; at least one battery in the wing; and lead wires electrically connecting leads of the at least one battery to the electricity-consuming component. The lead wires pass through a coupling between the wing and the fuselage.

According to yet another aspect of the invention, a method of making an unmanned aerial vehicle (UAV) includes the steps of: placing an electricity-consuming component in a fuselage of the UAV; placing at least one battery in a wing of the UAV that is connected to the fuselage; and electrically connecting the at least one battery to the electricity-consuming component, to thereby provide electric power for the electricity-consuming component.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

In the annexed drawings, which are not necessarily to scale:

FIG. 1 is a perspective drawing of a UAV according to the present invention;

FIG. 2 is a schematic view of the battery connections of the UAV of FIG. 1;

FIG. 3 is a close-up view of a portion of the wing and fuselage of the UAV of FIG. 1;

FIG. 4 is a cross-sectional view of the wing, along the section 4-4 shown of FIG. 3; and

FIG. 5 is another cross-sectional view of the wing, showing example load paths of the wing structure.

### DETAILED DESCRIPTION

An unmanned aerial vehicle, such as a remotely-piloted airplane, includes lift-producing wings that have batteries embedded or otherwise located within them. Locating the batteries within the wings allows more efficient use of the interior space of the unmanned vehicle. Space within a fuselage of the vehicle, which would otherwise be used for batteries, may be used for other components. Alternatively, fuselage, weight and/or size of the unmanned aerial vehicle may be reduced. In addition, locating the batteries within the wings may provide better structural performance of the wings, and/or may allow characteristics of the wings, such as inertia and moments, to be optimized.

Turning initially to FIG. 1, an unmanned aerial vehicle (UAV) 10 is shown. The term unmanned aerial vehicle, as used herein, encompasses a wide variety of winged pilotless air vehicles. UAVs include remotely-piloted airplanes, such as drones. In addition, UAVs include non-ballistic missiles, such as cruise missiles, which have lift-producing wings. In particular, the term encompasses small principally on batteries to provide electric power.

The UAV 10 includes a fuselage 12 that has wings 14 and control fins 16 connected to it. The fuselage 12 includes or encloses the main components of the UAV 10. Included in the fuselage 12 are an engine 20, electricity-consuming components 22, and a payload 24. The engine 20 may be any of a wide variety of suitable means for providing thrust for the UAV 10. Thus the engine 20 may be a rocket motor or a jet engine, or may be another suitable thrust-generating device, such as a propeller engine. As an alternative, the UAV 10 may be an engineless guided vehicle, such as dropped from an airplane or launched from a gun. The electricity-consuming components 22 may include a wide variety of electronics and electrical equipment, such as radar equipment, guidance equipment, communications equipment, flight control actuators, computers, electro-optical and other types of sensors, and/or radar or electronic jamming equipment.

The payload 24 may include any of a variety of components or equipment to be carried by the UAV 10. For example, if the UAV 10 is a missile, the payload 24 may include explosives or other munitions. Alternatively, if the UAV 10 is a reconnaissance vehicle, the payload 24 may include camera equipment or sensors. Thus, the payload 24 may itself include components that consume electricity. It will be appreciated that there are many possible payloads for the UAV 10, depending for instance on what type of UAV is utilized, and the mission for which the UAV is outfitted.

The wings 14 are lift-producing devices that have batteries 30 embedded or otherwise at least partially within them. The wings 14 may be fixed relative to the fuselage 12, or alternatively, may be articulatable relative to the fuselage 12.

The fins 16 may be used to stabilize the UAV 10 during flight. In addition, the fins 16 may be used as control surfaces for controlling the direction of the UAV 10. Alternatively or in addition, parts or all of the wings 14 may be used as control surfaces for controlling flight direction of the UAV 10. Further, the control surfaces may be placed elsewhere or the fuselage 12, such as forward of the wings 14, acting as canards.

It will be appreciated that the general configuration of the UAV 10 shown in FIG. 1 is an example for illustration purposes only, and that the shape, location, and/or other characteristics of the various parts of the UAV 10 may be suitably varied.

The batteries 30 are coupled to the electricity-consuming components 22, so as to provide energy for operating the electricity-consuming components 22.

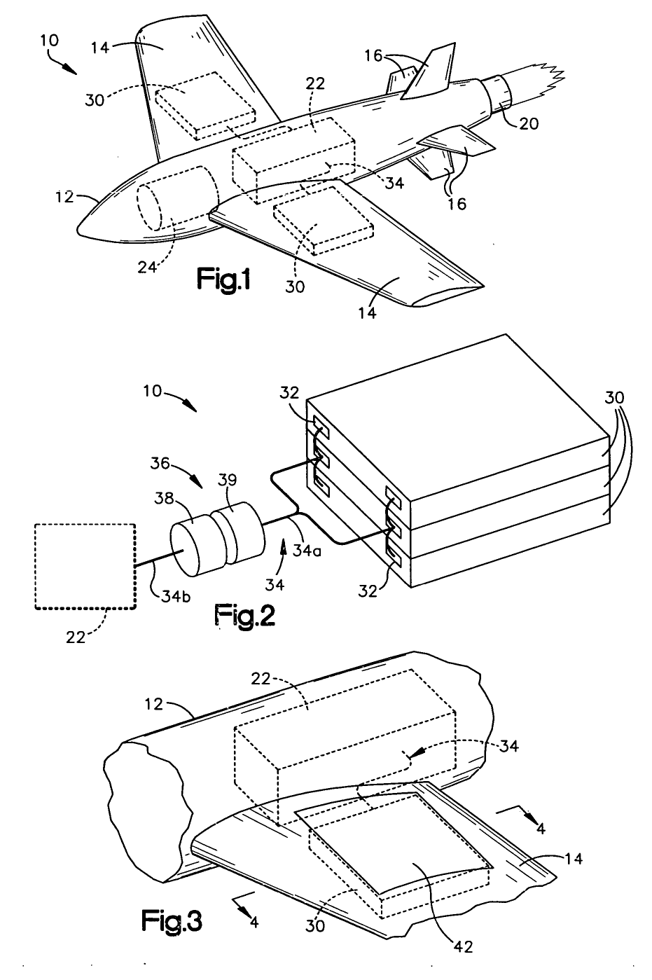

As illustrated in FIG. 2, each of the wings 14 may have multiple batteries or battery cells 30, which may be stacked one upon another. Leads 32 of the batteries 30 may be suitably coupled together, in series and/or in parallel, to provide desired voltages and discharge rates for operating the electricity-consuming components 22. Lead wires or cables 34 connect the leads 32 of the batteries 30 to the electricity-consuming components 22. In passing between the wing 14 and the fuselage 12, the lead wires 34 may pass through a conduit or connector 36. The conduit or connector 36 may include matable, separable portions 38 and 39 for coupling and de-coupling. The portions 38 and 39 may be quick-release portions that allow the wing 14 to be separately assembled and/or to be removable relative to the fuselage 12. The lead wires or cables 34 may have separate parts 34a and 34b, to allow for separation at the conduit or connector 36.

The conduit or connector 36 may be suitable for use even where the wings 14 are articulatable relative to the fuselage 12, since the range of motion of the wings 14 may be limited so that flexibility in the lead wires 34 may be sufficient to maintain the connection between the leads 32 and the electricity-consuming components 22. In cases where the range of motion of the wings 14 is not as limited, for example in the case of rotary wings, the conduit or connector 36 may incorporate slip rings or similar devices to maintain the connection between the leads 32 and the electricity-consuming components 22.

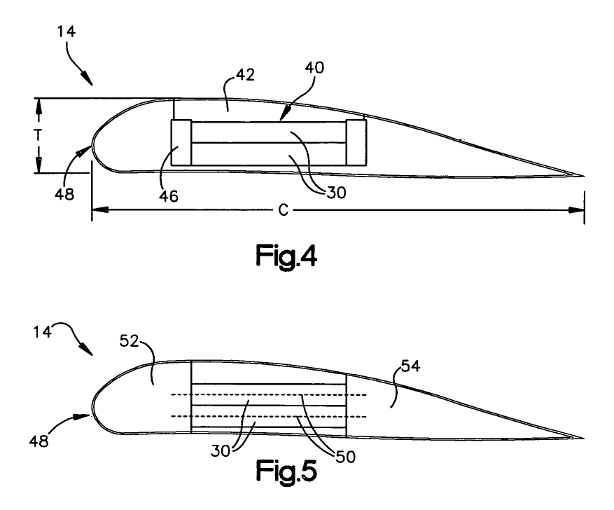

Turning now to FIGS. 3 and 4, further details are shown of the batteries 30 and the wing 14. The batteries 30 are located in a cavity 40 within the wing 14. An access door or panel 42 may be used for access to the batteries 30 within the cavity 40, for example, to load, unload, and/or recharge the batteries 30. The cavity 40 may have a shock-absorbing liner 46, for example, a material such as urethane or silicone rubber. The liner 46 aids in immobilizing the batteries 30, and in protecting the batteries 30, the leads 32, and the lead wires 34, from stresses and/or damage due to shocks or other loads on the wing 14.

The wing 14 includes a wing structure 48 for providing mechanical support for the wing 14 to withstand stresses it experiences, such as stresses due to aerodynamic forces and stresses due to the need to support the weight of the wing 14. The wing structure 48 may be made of a metal, such as aluminum, or may be made of a composite material. An example composite material is molded fiber-reinforced composites. An example of a metal wing is a solid aluminum wing, which may be machined to produce cavities for the batteries 30 or other components to be located therein. Materials for such composites may include graphite, Kevlar, and fiberglass for skins and internal structures, and foam or honeycomb materials for cores of the structure.

The wing structure 48 may be molded around the batteries 30, such that the batteries are non-removably embedded in the wing structure 48. Alternatively, as shown in FIGS. 3 and 4, the batteries may be removably placeable within the wing 14 after construction of the wing 14, for example, through the access door or panel 42.

The batteries 30 and the cavity 40 may be arranged so as to fit within a wing structure having a specified thickness T and chord C. The thickness T of the wing structure varies widely according to the nature of the UAV 10, but may be less than about 13 mm (0.5 inch), or may be up to several inches (about 100 mm) thick. As shown in FIGS. 2 and 4, the batteries 30 may be in stacks, with some of the batteries 30 stacked upon other of the batteries 30 within the cavity 40. The batteries 30 may have a thickness of less than about 1 mm (0.04 inches).

The batteries 30 may include any of a variety of suitable chemistries. Examples of suitable battery chemistries, which provide for high energy density, are lithium-ion-polymer batteries, lithium-sulfur batteries, silver polymer, and zinc matrix batteries. It will be appreciated that batteries utilizing these chemistries are available in various sizes, shapes, and other characteristscs. The batteries 30 may include prismatic cells and/or sachet cells (“pouch” cells with plastic film packaging surrounding the electrodes).

The batteries 30 themselves may function as structural elements within the wings 14, for example, transmitting compressive loads from and to other portions of the wing structure 48. For example, as illustrated in FIG. 5, the batteries 30 themselves may be part of load paths 50 for transmitting loads, such as aerodynamic loads, through the wing structure 48 of the wing 14. That is, if the batteries 30 were replaced by empty space or elements incapable of withstanding significant loads, the load paths 50 for transmitted loads within the wing structure 48 would be shifted, and/or loads within the wing structure 48 would be increased.

The batteries 30 may be made to function as structural elements by, for example, placing structural elements 52 and 54 of the wing structure 48 in contact with the batteries 30, on opposite sides of the batteries 30. Although the structural elements 52 and 54 are shown in FIG. 5 as separate parts, it will be understood that the structural elements 52 and 54 may in fact be different portions of a unitary structure, such as a molded structure. Also, it will be appreciated that the load paths 50 supported by the batteries 30 may extend in any of a variety of directions within the wing 14.

It will be appreciated that the batteries 30 will generally have a mass greater than that of the remainder of the wing 14. The batteries 30 may be placed within the wing 14 to tailor inertias and moments within the wing structure 48.

The mass of the batteries 30 may be distributed along the wingspan of the wings 14. This addition and distribution of mass, due to the placement of the batteries 30 within the wings 14, may reduce wing root bending moments relative to air vehicles having batteries within the fuselage.

It will be appreciated that there may be numerous heat-producing devices within the fuselage 12, including the electricity-consuming components 22 and the engine 20. Placing the batteries 30 in the wings 14 as opposed to in the fuselage 12, may improve heat dissipation characteristics, and thereby performance, of the UAV 10. Placing the batteries 30 in the wings 14 may allow the wings 14 to act as heat-dissipating fins, dissipating heat generated by the batteries 30 and preventing heat generated by the batteries 30 from reaching the fuselage 12 and possibly adversely affecting performance of components within the fuselage 12. Also, the wings 14 with the batteries 30 in them may dissipate heat produced by components within the fuselage 12, preventing such heat from heating up and adversely affecting performance of the batteries 30.

The batteries 30 may have greater thermal conductivity than other parts of the wing 14 (for example other wing parts made of composite material), which may aid in heat dissipation from components in the fuselage 12, compared to low-thermal-conductivity wings not having batteries wholly partially therewithin. Alternatively the batteries 30 may have a lower thermal conductivity than other parts of the wing 14 (for example other wing parts made of a metal, such as aluminum), which may allow for rapid dissipation of heat produced by the batteries 30.

It will be appreciated that a wide variety of suitable configurations for the batteries 30 within the wings 14 may be used. The batteries 30 may be placed together, as shown in the figures. Alternatively, one or more of the batteries 30 may be in a location separate from the other of the batteries 30, within the same wing 14.

The wing 14 with the batteries 30 may also allow for easier servicing/maintenance of the UAV 10. Battery replacement or recharging may be accomplished in situ, or by replacement of the wing 14 in toto, as opposed to having to service the fuselage of the UAV, as may be required in prior systems. It will be appreciated that swap-out of wings may be a faster and less labor-intensive than accessing a crowded fuselage to perform maintenance.

The batteries 30 may have a wide variety of suitable characteristics. A suitable airfoil shape may be selected to accommodate suitable batteries.

The UAV 10 as described above, with the batteries 30 partially or wholly within the wings 14, thus provides several advantages over UAVs having batteries fully within their fuselages. More efficient use of space is provided, with the ability to locate additional equipment within the fuselage 12, or to make the fuselage 12 smaller, due to the placement of the batteries 30 within the wings 14. Certain components utilized in prior art UAVs 10 such as heat insulation or batteries within a fuselage, may be omitted, thus resulting in a savings of size, weight, cost, and complexity. Serviceability may also be improved, in that the batteries 30 may be installed, replaced, serviced, and/or recharged, without the need for opening or disassembling the fuselage 12. Further, the batteries 30 may be placed so as to tailor inertias and moments of the wings 14, so as to provide improved performance of the UAV 10. Also, wing root bending moments of the wings 14 may be reduced by the placement of the batteries 30 within the wings 14, such as by distribution of the batteries 30 along the wing span of the UAV 10. Finally, placement of the batteries 30 wholly or partially within the wings may create a better heat environment for the both the batteries 30 and for the components within the fuselage 12.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1-2. (Canceled).

3. An unmanned aerial vehicle (UAV) comprising:
a fuselage;
a wing connected to the fuselage; and
at least one battery at least partially in the wing;
wherein the at least one battery is completely in the wing;
wherein the at least one battery is within a cavity in the wing; and
further comprising a liner in the cavity at least partially around the at least one battery.

4. The UAV of claim 3, wherein the liner includes a material selected from the group consisting of urethane and silicone rubber.

5. The UAV of claim 3, wherein the at least one battery is part of a wing structure providing mechanical support for the wing.

6. The UAV of claim 5, wherein a structural load path through the wing passes through the at least one battery.

7. An unmanned aerial vehicle (UAV) comprising:
a fuselage;
a wing connected to the fuselage;
at least one battery at least partially in the wing; and
an electricity-consuming component in the fuselage, wherein the component is electrically coupled to the at least one battery.

8. The UAV of claim 7, further comprising lead wires connecting leads of the at least one battery to the electricity-consuming component.

9. The UAV of claim 8, wherein the lead wires pass through a coupling between the wing and the fuselage.

10. The UAV of claim 9,
wherein the coupling includes separable, matable portions; and
wherein the portions are coupled to respective parts of the lead wires.

11. The UAV of claim 3, wherein the wing is made of aluminum.

12. The UAV of claim 3, wherein the wing is made of a composite material.

13. The UAV of claim 12, wherein the composite material is fabricated around the at least one battery.

14. The UAV of claim 13, wherein the composite material is molded around the at least one battery.

15. The UAV of claim 3, wherein the at least battery is selected from the group consisting of sachet cells and prismatic cells.

16. An unmanned aerial vehicle (UAV) comprising:
a fuselage;
an electricity-consuming component in the fuselage;
a wing connected to the fuselage;
at least one battery in the wing; and
lead wires electrically connecting leads of the at least one battery to the electricity-consuming component;
wherein the lead wires pass through a coupling between the wing and the fuselage; and
wherein the coupling includes matable portions.

17. (Canceled)

18. The UAV of claim 3, wherein the at least one battery includes a self-contained battery that is removable from the cavity.

19. The UAV of claim 18, wherein the wing includes an access door that allows access to the at least one battery within the cavity.

20. The UAV of claim 3, wherein the at least one battery is heavier than the wing.

21. The UAV of claim 3, wherein the wing includes an access door that allows access to the at least one battery within the cavity.

22. The UAV of claim 10, wherein the matable portions are quick-release portions.

23. The UAV of claim 16, wherein the separable, matable portions are quick-release portions.
